(19) United States
(12) Patent Application Publication
(10) Pub. No.: US 2015/0135096 A1
(43) Pub. Date: May 14, 2015

(54) SYSTEM AND METHOD FOR DISPLAYING CONTEXT-AWARE CONTACT DETAILS

(71) Applicant: Avaya Inc., Basking Ridge, NJ (US)

(72) Inventors: Krishna Kishore DHARA, Dayton, NJ (US); Venkatesh KRISHNASWAMY, Holmdel, NJ (US)

(73) Assignee: Avaya Inc., Basking Ridge, NJ (US)

(21) Appl. No.: 14/080,385

(22) Filed: Nov. 14, 2013

(51) Int. Cl. H04L 29/06; G06F 3/0482

(52) U.S. Cl. CPC H04L 65/403; G06F 3/0482
USPC 715/753; 715/808

(57) ABSTRACT

Disclosed herein are systems, methods, and computer-readable storage media for displaying context-aware contact details. An example system gathers information associated with behavior of a first user, wherein a list of contacts on a communication system for a second user contains the first user. The system can select, from the information, an information snippet related to a current activity context of one of the first user or the second user. The system displays the information snippet to the second user while the second user interacts with an identifier of the first user in the current activity context. In one variation, the system can further detect a request for information from the second user, and display the information snippet to the second user in response to the request.

### BACKGROUND

1. Technical Field

The present disclosure relates to communication environments and more specifically to identifying and presenting context- and contact-specific information in a communication environment.

2. Introduction

In a rich communication environment, users often deal with and manage a large number of contacts, sometimes ranging into the hundreds or even thousands of contacts. Each contact can have multiple pieces of information such as name, phone number, email address, home address, and so forth. Modern communication systems typically manage and provide access to such vast amounts of information via a contact list, or directory of people and associated information. A communication system can retrieve information from the contact list to provide to a user. For example, when the user makes a voice over IP phone call to a colleague, the communication system can display the picture of the colleague on the communication device for easy identification. In another example, in a multi-party audio conference, when a user moves the mouse pointer over a name or icon of a contact, the conference system can display a pop-up window to show more detailed contact information for that contact.

The information pertaining to the contacts in the contact list is limited to basic contact information that is either static and seldom changed over time, information pulled from a corporate directory or some other data source, such as a social network or an instant messaging server. These data sources provide only the most basic information, such as phone number and email address, and do not endeavor to provide additional information which may be useful or relevant to the user in that particular communication context.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

An example communication environment, communication system, or communication client can expand beyond providing static information about contacts in a contact list, and can display more detailed, context-aware, intelligent information snippets about one or more contacts in the contact list. Specifically, the communication system can gather information about the past and present behaviors of each individual in a contact list, such as various statistics and communication history. Then, at a later time, the communication system can display the appropriate information about the contacts in the contact list in a non-obtrusive way, such as via a pop-up dialog window in a graphical user interface of a laptop or video conferencing device, on a second screen device such as a tablet or smartphone, or via a wearable computing device such as smart glasses or a smart watch. The communication system can select which information to display to the user based on current and/or previous context or activities of the user and/or an indicated contact.

In a teleconferencing system, when a user hovers a mouse pointer over a name or icon of a contact, the system can display a pop-up window with not only “basic” information such as a profile picture, contact information, or a phone number. The system can also display a graph highlighting the communication history between the user and the person, for example. During a conference call or other meeting, if one of the expected participants is late to join, the system can present a pop-up indicating whether the missing expected participant has a tendency to be tardy based on past meeting records, can show his current location based on location data reported by his or her smartphone, can show his or her presence information, or can prepare an editable one-click option to send him or her a text message. For example, the system can prepare a one-click option to send a message “What is your ETA?” but users can edit the body of the message or to where the message will be directed prior to clicking

This approach presents context-specific relevant information or communication options dynamically rather than providing fixed or simple generic contact information. The system gathers information about user behavior statistics, selects part of the information that is relevant to another user given a current context and a similarity of that current context to previously recorded context situations, and displays the information in an unobtrusive way or makes it available or easily discoverable for the user.

Disclosed are systems, methods, and non-transitory computer-readable storage media for displaying context-aware contact details. An example system can gather information associated with behavior of a first user, wherein a list of contacts on a communication system for a second user contains the first user. The system can select, from the information, an information snippet related to a current activity context of one of the first user or the second user. The system can display the information snippet to the second user while the second user interacts with an identifier of the first user on the communication system in the current activity context. The information snippet can include, but is not limited to, a conversation history between the first user and the second user, context-specific data related to the first user, a document, an address, contact information of the first user, an image, an email message, availability of the first user, presence information of the first user, or relationship information between the first user and the second user. In one variation, the system can further detect an information requesting event from the second user, and display the information snippet to the second user in response to the information requesting event. The information requesting event can be, for example, placing a mouse pointer over an avatar of the first user, clicking on an icon associated with the first user, a spoken voice command, a text query, a gesture, the first user joining a communication session, or receipt of a meeting invite. The system can gather information associated with behavior of a first user by identifying data sources associated with the first user, and requesting from the data sources parts of the information that also relate to the second user or to the current activity context.

Further, the system can track how the second user interacts with the information snippet, and modify how additional information snippets are selected based on how the second user interacts with the information snippet. In another variation, the system can also retrieve permissions associated with the first user, and select the information snippet related to a current activity context based on the permissions.

### BRIEF DESCRIPTION OF THE DRAWINGS

FIG. 1 illustrates an example communications architecture;

FIG. 2 illustrates an example communication device;

FIGS. 3A-3D illustrate example user interfaces for a video conference;

FIG. 4 illustrates an example user interface for an audio conference;

FIG. 5 illustrates an example method embodiment; and

FIG. 6 illustrates an example system embodiment.

### DETAILED DESCRIPTION

Various embodiments of the disclosure are described in detail below. While specific implementations are described, it should be understood that this is done for illustration purposes only. Other components and configurations may be used without parting from the spirit and scope of the disclosure. The present disclosure addresses identifying and presenting context-specific contact information in a non-obtrusive way. Multiple variations shall be described herein as the various embodiments are set forth.

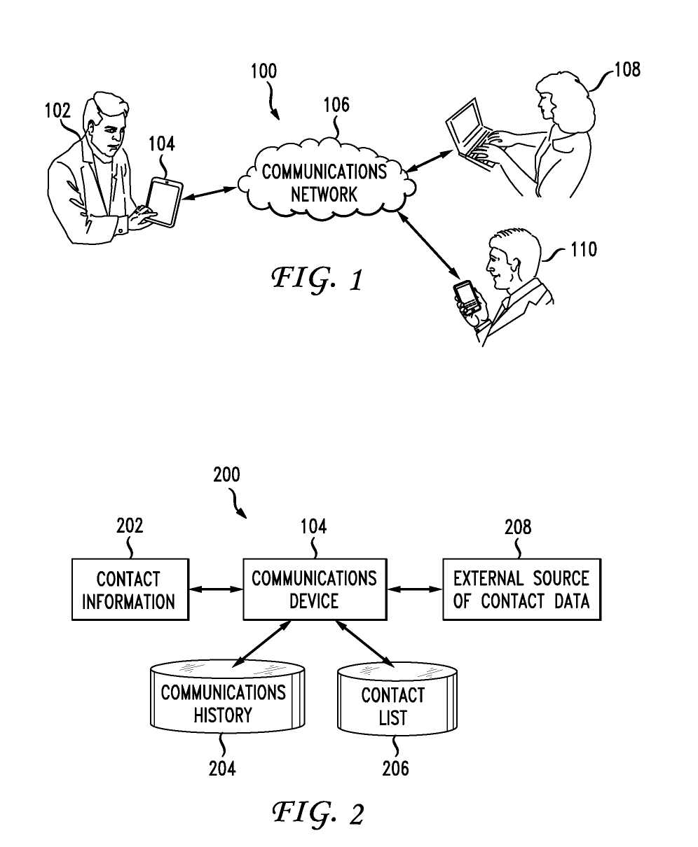

FIG. 1 illustrates an example communications architecture 100 in which a user 102 communicates via a communications device 104 with other users 108, 110 over a network 106. The communications device 104 can store contact information of the other users 108, 110 and can track and record information describing a current communication context. Then the communications device 104 can provide context-specific contact information either on-demand or in an event-driven or context-driven mode during communication sessions.

FIG. 2 illustrates some details of an example architecture 200 of the communications device 104. The communications device 104 can retrieve contact information 202 from various sources, internal or external. For example, the contact information 202 can be harvested from received emails or messages, or a local contact list 206 or address book. The communications device 104 can also retrieve information from various external sources 208 of contact data. For example, after identifying a contact the communications device 104 can retrieve additional contact data from social networks or other network sources, such as an internal employee directory or a public employee directory. The communications device 104 can retrieve contact data and cache that data for future use. Further, the communications device 104 can monitor a communications history 204 between the user 102 and other users 108, 110. The communications history 204 can provide valuable context information that the communications device 104 can use to determine whether and what type of data to present.

An example communications device 104 acting as a context-specific contact information system can offer a richer experience when interacting with an identifier or representation of a contact in a contact list. The identifier or representation of the contact can be a name, an icon, a photo, an ID number, a dial-in number, a label, an animation, and so forth. The exact type of identifier or representation can vary from device type to device type, and can include other suitable identifiers not listed herein. The system can intelligently gather and display information that is most pertinent and helpful to a user depending on a current communication context. The context can reflect, for example, what the user and/or the contact are doing, what the user and/or the contact have scheduled or planned to do, presence information of either the user or the contact, and so forth. In one example, during a video conference a participant places the mouse pointer over another conference participant's avatar. In response, the system can display a pop-up window with additional context-sensitive information for that specific interaction and for that specific relationship between that pair of participants. The additional context-sensitive information can include information such as when the other participant joined the video conference, some of the topics that she has addressed during the conference so far, related email correspondence that you had exchanged with her prior to the conference, her current location, documents recently discussed by the two participants, social networking messages, common friends, joint task items, and so forth. The communication system can monitor participants' behavior as they interact with the system and with each other. When multiple participants are interacting with each other via the system, the system can use this information as well as additional context information to enhance the experience by identifying, retrieving, and providing dynamically selected or generated contact data, suggestions, or actions based on the current context.

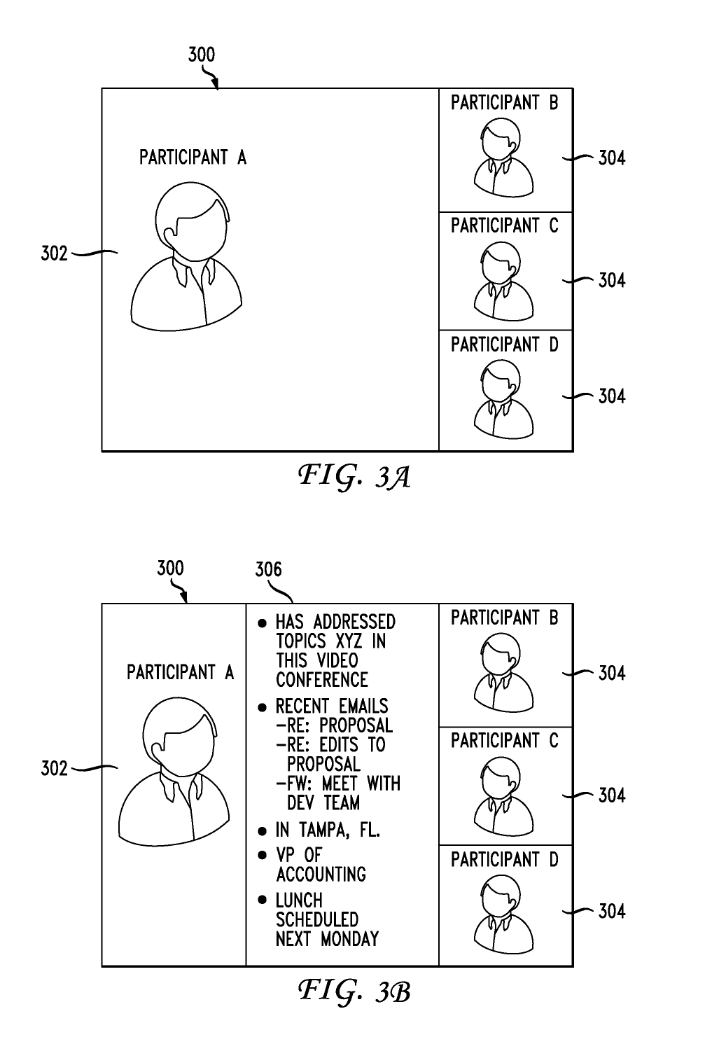

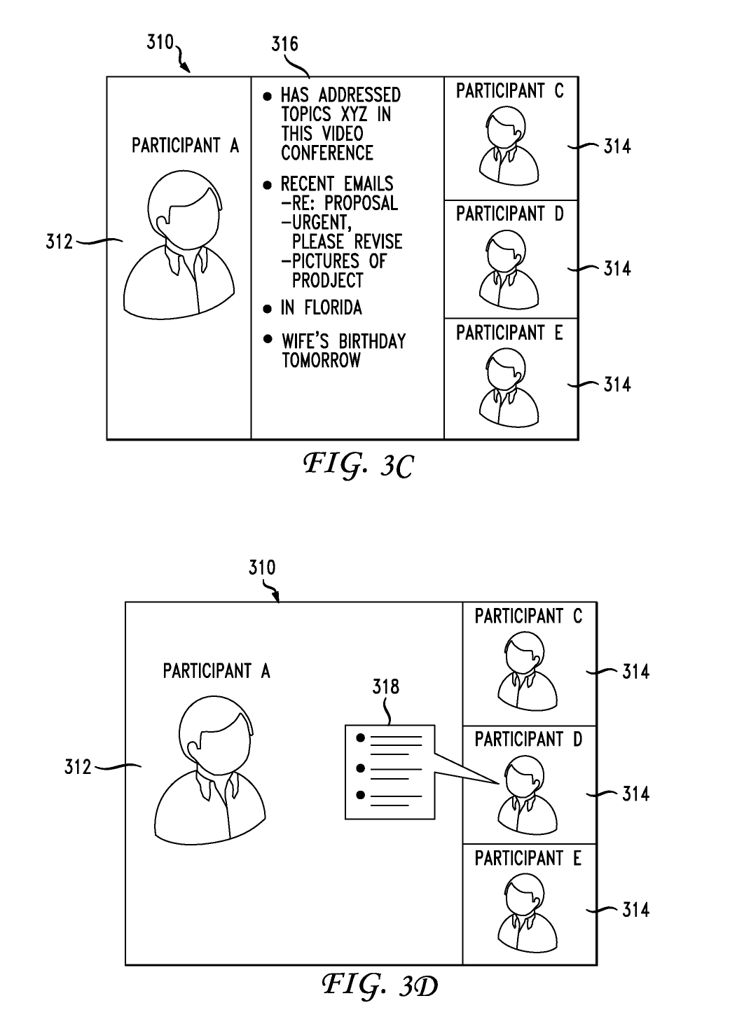

FIGS. 3A-3D illustrate example user interfaces for a video conference showing different example implementations of displaying context-aware contact details. The contact details can be descriptive of attributes of the contact, descriptive of tasks associated with the contact, descriptive of past interactions or relationships between the user and that contact, and so forth. The types and quantity of contact details displayed can depend on the context. FIG. 3A shows an example user interface 300 in which participant E (not shown) is in a video conference with other participants. Participant A 302 is featured larger because he is an active speaker in the conference, whereas participants B, C, and D 304 are featured smaller because they are not actively speaking at the moment. FIG. 3A does not show any context-aware contact details.

FIG. 3B shows the user interface 300 with the same arrangement of participants 302, 304 as FIG. 3A in which participant E (not shown) is in a video conference with other participants, but with context-aware contact details 306. In this example, the communications device 104 identifies the context, such as topics that participant A 302 is discussing, previous interactions between participant E and participant A 302, location data of participant A 302, organizational data relevant to participant E about participant A, and so forth. The communications device 104 can use the context to identify relevant pieces of data to display about participant A and/or about the context, rank the importance of the data to display, and present the context-aware contact details that have the highest importance. The communications device 104 can present the context-aware contact details automatically or based on a user request, such as the user hovering a mouse cursor over a contact icon, tapping on the contact icon, zooming in on a contact icon, and so forth. The user can establish certain conditions that, when satisfied, cause the communications device 104 to present context-aware contact details. For example, when the active speaker has not been the active speaker in the last 5 minutes, the communications device 104 can automatically retrieve and present context-aware contact details. The communications device 104 can automatically present context-aware contact details for each participant at the beginning of every conference call.

FIG. 3C shows a user interface 310 of the same video conference depicted in FIGS. 3A and 3B, but from the perspective of participant B. On this user interface 310, participant A 312 is still depicted larger because he is the active speaker, while the other participants 314 are depicted smaller because they are not the active speakers. The user interface provides context-aware contact details 316 for participant A 312 that are different from the context-aware contact details 306 shown in FIG. 3B, because the context between participants B and A is different than between participants E and A. While certain pieces of context-aware contact details may be the same, such as which topics participant A has addressed in this video conference, other details may be different in granularity or may be completely different. For example, FIG. 3B shows that participant A is in Tampa, Fla., while FIG. 3C shows that participant A is just in Florida. In FIG. 3C, the context information may reflect a personal relationship between participants B and A, causing other information, such as the wife's birthday tomorrow. Further, the recent emails between the different pairs of participants may differ. When assigning priorities to various pieces of context data, the system can consider recency, so that the most recent communications are assigned a greater priority. FIG. 3D shows the user interface 310 of the same video conference depicted in FIG. 3C, but with context-aware contact details 318 provided for a non-active speaker, in this case participant D. As shown, the communications device 104 can present these context-aware contact details 318 as a popup upon request of the user. This approach can allow the user to quickly and easily locate information that is relevant to a specific context, without cluttering the user interface or obscuring the video feeds from other participants.

The communications device 104 can monitor context continuously and prepare or maintain a set of context-aware contact details for each other participant in the video conference so that the communications device 104 is ready to present that information upon a user request. Alternatively, the communications device 104 can receive a request to display context-aware contact details, determine context after receiving the request, and then fetch the contact details for display based on the context. This approach may introduce some latency or delay while the communications device 104 gathers context information and then gathers contact details.

While FIGS. 3A-3D depict presenting the video conference and context-aware contact details on a single display, the system can incorporate multiple displays. For example, the communications device 104 can display the video conference, while a second device displays the context-aware contact details, such as a tablet, smartphone, or second computer. The communications device 104 can transmit the context-aware contact details to the second display, or another device such as a network server can transmit the context-aware contact details. In one embodiment, the user views the video conference on a laptop computer, and receives, via his or her cellular phone, periodic text messages containing relevant context-aware contact details. This approach can also apply to audio-only conferences or other conferences without a video or graphical component.

In another variation, the communications device 104 can deliver context-aware contact details to the user via a non-visual channel. For example, the communications device 104 can use a whisper or text-to-speech voice to provide context-aware contact details in a left audio channel while the audio-only conference continues in the right audio channel. In this way, even in a display-less interface the user can still receive context-aware contact details.

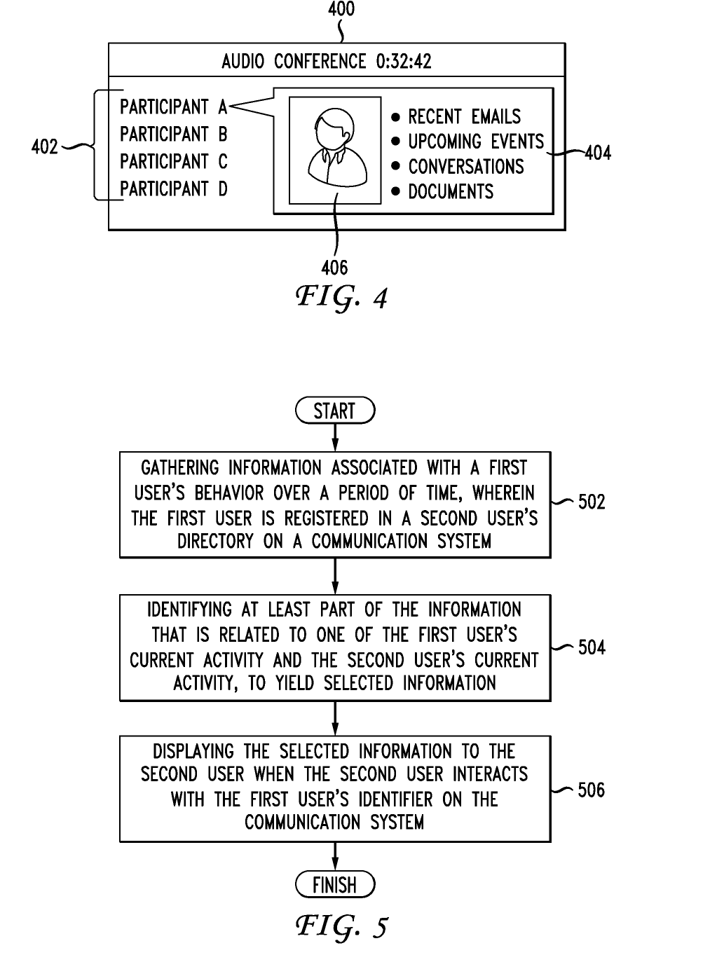

FIG. 4 illustrates an example graphical user interface 400 for an audio conference in which context-aware contact details are provided. The user interface 400 can include a list of participants 402, and can display an image 406 of a particular participant as well as various context-aware contact details 404 about that participant. The user can drill down, open, or expand the various contact details 404 presented. This example graphical user interface 400 also demonstrates that contact details 404 can include text content, but also images, audio, animations, movie clips, or other forms of multimedia content.

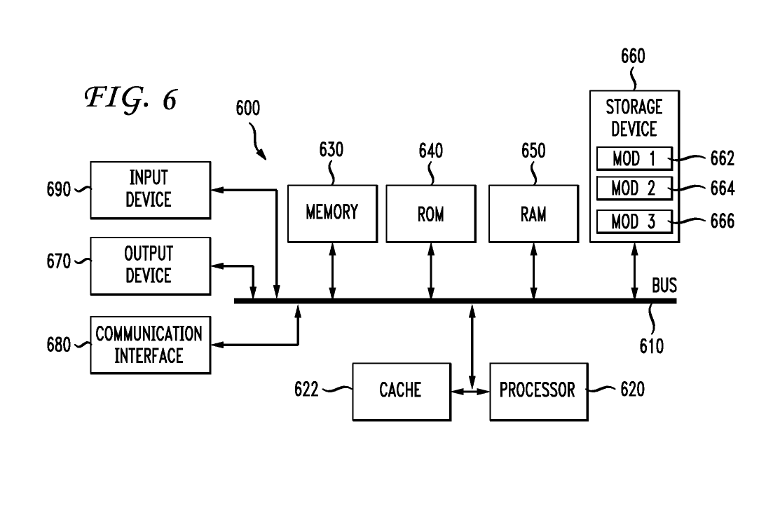

Having disclosed some basic system components and concepts, the disclosure now turns to the exemplary method embodiment shown in FIG. 5. For the sake of clarity, the method is described in terms of an exemplary system 600 as shown in FIG. 6 configured to practice the method. The steps outlined herein are exemplary and can be implemented in any combination thereof, including combinations that exclude, add, or modify certain steps.

The example system can gather information associated with behavior of a first user, wherein a list of contacts on a communication system for a second user contains the first user (502). The system can select, from the information, an information snippet related to a current activity context of one of the first user or the second user (504). The system can display the information snippet to the second user while the second user interacts with an identifier of the first user on the communication system in the current activity context (506). The information snippet can include, but is not limited to, a conversation history between the first user and the second user, context-specific data related to the first user, a document, an address, contact information of the first user, an image, an email message, availability of the first user, presence information of the first user, or relationship information between the first user and the second user. In one variation, the system can further detect an information requesting event from the second user, and display the information snippet to the second user in response to the information requesting event. The information requesting event can be, for example, placing a mouse pointer over an avatar of the first user, clicking on an icon associated with the first user, a spoken voice command, a text query, a gesture, the first user joining a communication session, or receipt of a meeting invite. The system can gather information associated with behavior of a first user by identifying data sources associated with the first user, and requesting from the data sources parts of the information that also relate to the second user or to the current activity context.

Further, the system can track how the second user interacts with the information snippet, and modify how additional information snippets are selected based on how the second user interacts with the information snippet. In another variation, the system can also retrieve permissions associated with the first user, and select the information snippet related to a current activity context based on the permissions.

A brief description of a basic general purpose system or computing device in FIG. 1 which can be employed to practice the concepts is disclosed herein. FIG. 1 illustrates an example general-purpose computing device 100, including a processing unit (CPU or processor) 120 and a system bus 110 that couples various system components including the system memory 130 such as read only memory (ROM) 140 and random access memory (RAM) 150 to the processor 120. The system 100 can include a cache 122 of high speed memory connected directly with, in close proximity to, or integrated as part of the processor 120. The system 100 copies data from the memory 130 and/or the storage device 160 to the cache 122 for quick access by the processor 120. In this way, the cache provides a performance boost that avoids processor 120 delays while waiting for data. These and other modules can control or be configured to control the processor 120 to perform various actions. Other system memory 130 may be available for use as well. The memory 130 can include multiple different types of memory with different performance characteristics. It can be appreciated that the disclosure may operate on a computing device 100 with more than one processor 120 or on a group or cluster of computing devices networked together to provide greater processing capability. The processor 120 can include any general purpose processor and a hardware module or software module, such as module 1 162, module 2 164, and module 3 166 stored in storage device 160, configured to control the processor 120 as well as a special-purpose processor where software instructions are incorporated into the actual processor design. The processor 120 may essentially be a completely self-contained computing system, containing multiple cores or processors, a bus, memory controller, cache, etc. A multi-core processor may be symmetric or asymmetric.

The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices 160 such as a hard disk drive, a magnetic disk drive, an optical disk drive, tape drive or the like. The storage device 160 can include software modules 162, 164, 166 for controlling the processor 120. Other hardware or software modules are contemplated. The storage device 160 is connected to the system bus 110 by a drive interface. The drives and the associated computer-readable storage media provide nonvolatile storage of computer-readable instructions, data structures, program modules and other data for the computing device 100. In one aspect, a hardware module that performs a particular function includes the software component stored in a tangible computer-readable storage medium in connection with the necessary hardware components, such as the processor 120, bus 110, display 170, and so forth, to carry out the function. In another aspect, the system can use a processor and computer-readable storage medium to store instructions which, when executed by the processor, cause the processor to perform a method or other specific actions. The basic components and appropriate variations are contemplated depending on the type of device, such as whether the device 100 is a small, handheld computing device, a desktop computer, or a computer server.

Although the exemplary embodiment described herein employs the hard disk 160, other types of computer-readable media which can store data that are accessible by a computer, such as magnetic cassettes, flash memory cards, digital versatile disks, cartridges, random access memories (RAMs) 150, read only memory (ROM) 140, a cable or wireless signal containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 100, an input device 190 represents any number of input mechanisms, such as a microphone for speech, a touch-sensitive screen for gesture or graphical input, keyboard, mouse, motion input, speech and so forth. An output device 170 can also be one or more of a number of output mechanisms known to those of skill in the art. In some instances, multimodal systems enable a user to provide multiple types of input to communicate with the computing device 100. The communications interface 180 generally governs and manages the user input and system output. There is no restriction on operating on any particular hardware arrangement and therefore the basic features here may easily be substituted for improved hardware or firmware arrangements as they are developed.

For clarity of explanation, the illustrative system embodiment is presented as including individual functional blocks including functional blocks labeled as a “processor” or processor 120. The functions these blocks represent may be provided through the use of either shared or dedicated hardware, including, but not limited to, hardware capable of executing software and hardware, such as a processor 120, that is purpose-built to operate as an equivalent to software executing on a general purpose processor. For example the functions of one or more processors presented in FIG. 1 may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 140 for storing software performing the operations described below, and random access memory (RAM) 150 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 100 shown in FIG. 1 can practice all or part of the recited methods, can be a part of the recited systems, and/or can operate according to instructions in the recited tangible computer-readable storage media. Such logical operations can be implemented as modules configured to control the processor 120 to perform particular functions according to the programming of the module. For example, FIG. 1 illustrates three modules Mod1 162, Mod2 164 and Mod3 166 which are modules configured to control the processor 120. These modules may be stored on the storage device 160 and loaded into RAM 150 or memory 130 at runtime or may be stored in other computer-readable memory locations.

Embodiments within the scope of the present disclosure may also include tangible and/or non-transitory computer-readable storage media for carrying or having computer-executable instructions or data structures stored thereon. Such tangible computer-readable storage media can be any available media that can be accessed by a general purpose or special purpose computer, including the functional design of any special purpose processor as described above. By way of example, and not limitation, such tangible computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein can be incorporated into a corporate unified communications server, a web-based instant messaging service, or any other communication platform or client. Various modifications and changes may be made to the principles described herein without following the example embodiments and applications illustrated and described herein, and without departing from the spirit and scope of the disclosure.

We claim:

1. A method comprising:
gathering, via a processor, information associated with behavior of a first user, wherein a list of contacts on a communication system for a second user contains the first user;
selecting, from the information, an information snippet related to a current activity context of one of the first user or the second user; and
displaying the information snippet to the second user while the second user interacts with an identifier of the first user on the communication system in the current activity context.

2. The method of claim 1, wherein the information snippet comprises at least one of a conversation history between the first user and the second user, context-specific data related to the first user, a document, an address, contact information of the first user, an image, an email message, availability of the first user, presence information of the first user, or relationship information between the first user and the second user.

3. The method of claim 1, further comprising:
detecting an information requesting event from the second user; and
displaying the information snippet to the second user in response to the information requesting event.

4. The method of claim 3, wherein the information requesting event comprises at least one of placing a mouse pointer over an avatar of the first user, clicking on an icon associated with the first user, a spoken voice command, a text query, a gesture, the first user joining a communication session, or receipt of a meeting invite.

5. The method of claim 1, wherein gathering the information associated with behavior of a first user further comprises:
identifying data sources associated with the first user; and
requesting from the data sources parts of the information that also relate to the second user or to the current activity context.

6. The method of claim 1, further comprising:
tracking how the second user interacts with the information snippet; and
modifying how additional information snippets are selected based on how the second user interacts with the information snippet.

7. The method of claim 1, further comprising:
retrieving permissions associated with the first user; and
selecting the information snippet related to a current activity context based on the permissions.

8. A system comprising:
a processor; and
a computer-readable storage medium storing instructions which, when executed by the processor, cause the processor to perform a method comprising:
gathering information associated with behavior of a first user, wherein a list of contacts on a communication system for a second user contains the first user;
selecting, from the information, an information snippet related to a current activity context of one of the first user or the second user; and
displaying the information snippet to the second user while the second user interacts with an identifier of the first user on the communication system in the current activity context.

9. The system of claim 8, wherein the information snippet comprises at least one of a conversation history between the first user and the second user, context-specific data related to the first user, a document, an address, contact information of the first user, an image, an email message, availability of the first user, presence information of the first user, or relationship information between the first user and the second user.

10. The system of claim 8, the computer-readable storage medium further stores instructions which result in the method further comprising:
detecting an information requesting event from the second user; and
displaying the information snippet to the second user in response to the information requesting event.

11. The system of claim 10, wherein the information requesting event comprises at least one of placing a mouse pointer over an avatar of the first user, clicking on an icon associated with the first user, a spoken voice command, a text query, a gesture, the first user joining a communication session, or receipt of a meeting invite.

12. The system of claim 8, wherein gathering the information associated with behavior of a first user further comprises:
identifying data sources associated with the first user; and
requesting from the data sources parts of the information that also relate to the second user or to the current activity context.

13. The system of claim 8, the computer-readable storage medium further stores instructions which result in the method further comprising:
tracking how the second user interacts with the information snippet; and
modifying how additional information snippets are selected based on how the second user interacts with the information snippet.

14. The system of claim 8, the computer-readable storage medium further stores instructions which result in the method further comprising:
retrieving permissions associated with the first user; and
selecting the information snippet related to a current activity context based on the permissions.

15. A non-transitory computer-readable storage medium storing instructions which, when executed by a computing device, cause the computing device to perform a method comprising:
gathering information associated with behavior of a first user, wherein a list of contacts on a communication system for a second user contains the first user;
selecting, from the information, an information snippet related to a current activity context of one of the first user or the second user; and
displaying the information snippet to the second user while the second user interacts with an identifier of the first user on the communication system in the current activity context.

16. The non-transitory computer-readable storage medium of claim 8, wherein the information snippet comprises at least one of a conversation history between the first user and the second user, context-specific data related to the first user, a document, an address, contact information of the first user, an image, an email message, availability of the first user, presence information of the first user, or relationship information between the first user and the second user.

17. The non-transitory computer-readable storage medium of claim 8, storing additional instructions which result in the method further comprising:
detecting an information requesting event from the second user; and
displaying the information snippet to the second user in response to the information requesting event.

18. The non-transitory computer-readable storage medium of claim 10, wherein the information requesting event comprises at least one of placing a mouse pointer over an avatar of the first user, clicking on an icon associated with the first user, a spoken voice command, a text query, a gesture, the first user joining a communication session, or receipt of a meeting invite.

19. The non-transitory computer-readable storage medium of claim 8, wherein gathering the information associated with behavior of a first user further comprises:
identifying data sources associated with the first user; and
requesting from the data sources parts of the information that also relate to the second user or to the current activity context.

20. The non-transitory computer-readable storage medium of claim 8, storing additional instructions which result in the method further comprising:
tracking how the second user interacts with the information snippet; and
modifying how additional information snippets are selected based on how the second user interacts with the information snippet.
